(19) United States
(12) Patent Application Publication
(10) Pub. No.: US 2011/0219662 A1
(43) Pub. Date: Sep. 15, 2011

(54) Electric Shock Fishing Lure Apparatus

(76) Inventor: Silvester R. McLaurin, New Haven, CT (US)

(21) Appl. No.: 13/037,524

(22) Filed: Mar. 1, 2011

Related U.S. Application Data
(60) Provisional application No. 61/340,185, filed on Mar. 15, 2010.

(51) Int. Cl. A01K 79/02; A01K 85/01

(52) U.S. Cl. 43/17.1

(57) ABSTRACT

An electric shock fishing lure apparatus includes a main housing body portion defining an interior area. A battery is positioned in the interior area. A conductive switch shaft is electrically connected to the battery and is situated in a distal end of the main body portion and movable between an extended configuration in which the switch shaft is energized by electrical current from the battery and a retracted configuration in which the switch shaft is not energized by current from the battery. A spring is coupled to the switch shaft and to the distal end of the housing for biasing the switch shaft toward the retracted configuration. A hook member is situated outside the interior area of the main housing body portion and operatively coupled to an outside end of the switch shaft, the electrically conductive hook member being energized when the switch shaft is at the extended configuration.

### CROSS REFERENCE TO RELATED APPLICATION

This non-provisional patent application claims the benefit of provisional application Ser. No. 61/340,185 filed on Mar. 15, 2010, titled Electric Shock Fishing Lure Apparatus.

### BACKGROUND OF THE INVENTION

This invention relates generally to fishing tackle and, more particularly, to a fishing lure apparatus that applies an electric shock to a fish and causes the lure's hook to become more deeply embedded in a fish's mouth.

Fishing has become a popular pastime and leisure activity more so than merely a means for catching fish as a food source. Many people enjoy the challenge of hooking a fish and the relaxation of being in the outdoors around a lake, pond, or stream. One of the challenges of fishing has always been properly setting the hook when a nibble or bite on the bait or lure is detected. If the hook is not embedded deeply enough, the fish may be lost while being reeled in.

Various devices have been proposed in the art that attempt to embed a hook in a fish's mouth such as multiple and complicated hook configurations. Although assumably effective for their intended purposes, the existing devices do not make use of a fish's own energy to embed a hook member more deeply and securely immediately upon receiving a lure into its mouth and moving away.

Therefore, it would be desirable to have an electric shock fishing lure apparatus that energizes a hook member to shock a fish when the fish tugs on the hook member, causing the hook member to become embedded more deeply in the fish's mouth.

### SUMMARY OF THE INVENTION

An electric shock fishing lure apparatus according to a preferred embodiment of the present invention includes a main housing body portion defining an interior area. A battery is positioned in the interior area. An electrically conductive switch shaft is electrically connected to the battery and is situated in a distal end of the main body portion and movable between an extended configuration in which the switch shaft is energized by electrical current from the battery and a retracted configuration in which the switch shaft is not energized by current from the battery. A compression spring is coupled to the switch shaft and to the distal end of the housing for biasing the switch shaft toward the retracted configuration. A conductive hook member is situated outside the interior area of the main housing body portion and operatively coupled to an outside end of the switch shaft, the electrically conductive hook member being energized when the switch shaft is at the extended configuration.

Therefore, a general object of this invention is to provide an electric shock fishing lure apparatus that energizes a hook member to shock a fish who has taken all or part of the lure into its mouth.

Another object of this invention is to provide an electric shock fishing lure apparatus, as aforesaid, that energizes the hook member when the hook member is urged away from the lure body portion, such as when the fish tries to swim away.

Still another object of this invention is to provide an electric shock fishing lure apparatus, as aforesaid, that is illuminated to attract fish.

Yet another object of this invention is to provide an electric shock fishing lure apparatus, as aforesaid, that is safe to use.

A further object of this invention is to provide an electric shock fishing lure apparatus, as aforesaid, that is durable and inexpensive.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a side view showing a preferred embodiment of the electric shock fishing lure apparatus of the invention, which includes a constantly glowing illumination source.

FIG. 2 is an enlarged view of a fish that is hooked onto the hook member of the apparatus of the invention shown in FIG. 1.

FIG. 3 is a cross-sectional view of the embodiment of the electric shock fishing lure apparatus of FIG. 1 taken along line 3-3 thereof.

FIG. 4 is an electrical schematic diagram of electric circuitry used with the preferred embodiment of the invention.

FIG. 5 is an enlarged view of the portion of the embodiment of the invention shown in FIG. 1, taken along line 5-5 thereof.

FIG. 6 is an enlarged, partially exploded view of the line-attachment end of the preferred embodiment of the invention, allowing easy access for changing the battery power source.

### DESCRIPTION OF THE PREFERRED EMBODIMENT

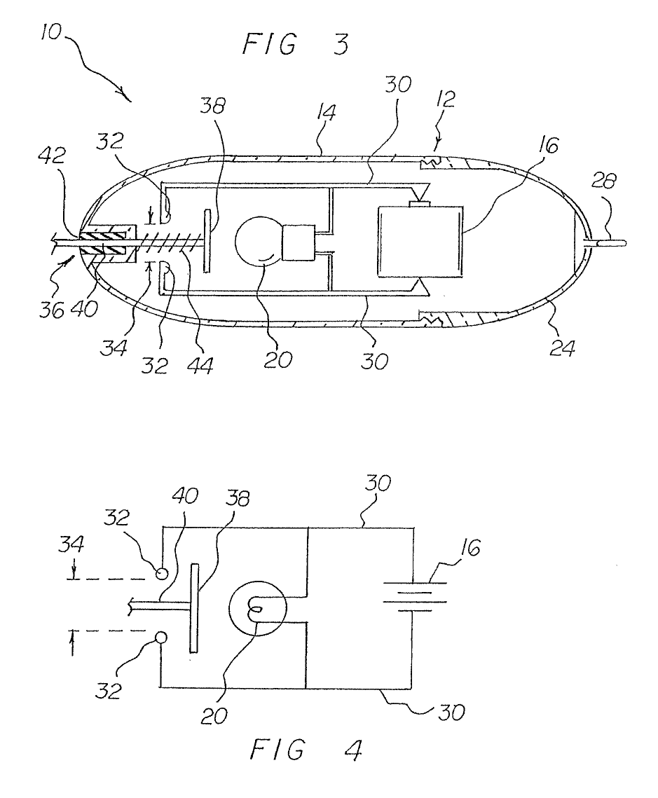

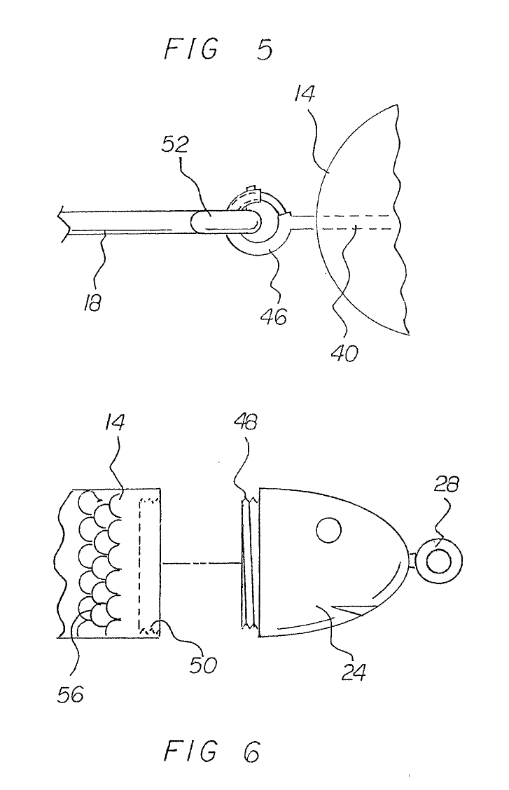

An electric shock fishing lure apparatus embodying the principles and concepts of the present invention will now be described in detail with reference to FIGS. 1 to 6 of the accompanying drawings.

Turning to FIGS. 1-6, there is shown a preferred embodiment of the electric shock fishing lure apparatus of the invention generally designated by reference numeral 10. In each of the figures, reference numerals are shown that correspond to like reference numerals that designate like elements shown in other figures.

In the preferred embodiment, electric shock fishing lure apparatus 10 includes an outside housing lure assembly 12 which includes a main housing body portion 14 and a housing cap portion 24 that is removably connected to the main housing body portion 14. The main housing body portion 14 defines an interior space so as to contain other components as will be described below. A line connector 28 is connected to the housing cap portion 24, and fishing line may be connected to the line connector 28. An electric shock unit 26 is housed substantially inside the main housing body portion 14, and an electrically conductive hook member 18 is connected to the electric shock unit 26.

When a fish 11 is hooked by the hook member 18 and pulls on the hook member 18, the electric shock unit 26 energizes the hook member and causes the fish 11 to feel an electric shock, thereby causing the fish 11 to spasm and thrash about, thus embedding the hook member 18 firmly into the fish's mouth.

Preferably, the housing lure assembly 12 includes semi-translucent scale structures 56. The electric shock unit 26 includes a battery power source 16, first and second electrical conductors 30 are electrically connected to the battery power source 16, wherein each of the first and second electrical conductors 30 includes a respective gap end 32. The respective gap ends 32 define an electrical gap 34 between them. An illumination source 20 is electrically connected to the first and second electrical conductors 30. The illumination source 20 may be a light emitting diode. A movable gap shunt switch assembly 36 is connected to a distal end of the main housing body portion 14. The movable gap shunt switch assembly 36 includes a watertight seal 42 that is connected to the distal end of the main housing body portion 14. An electrically conductive switch shaft 40 is received in the watertight seal 42 and is movable as described below.

An electrically conductive hook fastener 46 is connected to an outside end of the switch 40. An electrically conductive gap shunt portion 38 is connected to an inside end of the switch shaft 40, and a bias spring 44 is connected between the watertight seal 42 and the gap shunt portion 38. In the normal state, the bias spring 44 causes the gap shunt portion 38 to be out of contact with the gap end 32 so that the electric shock circuit is open. On the other hand, when the normal bias of the bias spring 44 is overcome, the gap shunt portion 38 contacts the gap ends 32, causing the electric shock circuit to be closed and the switch shaft 40 to be energized.

The housing cap portion 24 includes external threads 48, and the main housing body portion 14 includes complementary internal threads 50, whereby the external threads 48 of the housing cap portion 24 operatively engaged with the internal threads 50 of the main housing body portion 14 for attaching the housing cap portion 24 to the main housing body portion 14. When the housing cap portion 24 is removed, the components situated within the housing interior space are accessible.

More specifically, a fishing line (not shown) may be connected to the line connector 28. Also, the hook fastener 46 is operated so that an electrically conductive hook connection ring 52 is connected to the hook fastener 46. With a battery power source 16 installed inside the housing lure assembly 12, the electric shock fishing lure apparatus 10 is ready for use to catch a fish 11.

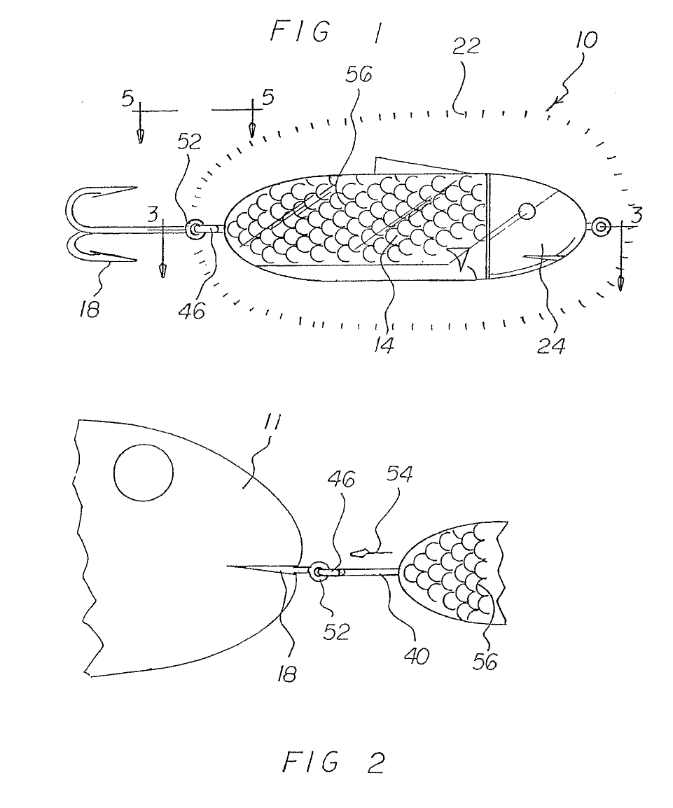

In operation, the electric shock fishing lure apparatus 10 with the hook member 18 attached thereto is lowered into the water (not shown). In the water, the illumination provided by the illumination source 20 shines through the semi-translucent scale structures 56, represented by illumination rays 22, and serves to attract fish to the electric shock fishing lure apparatus 10. When a fish 11 bites on the hook end of the hook member 18, and when the fish 11 tries to escape from the hook member 18, the fish 11 pulls the hook member 18 away from the housing lure assembly 12, as shown by directional arrow 54 in FIG. 2.

When the hook member 18 is pulled away from the housing lure assembly 12, the switch shaft 40 that is attached to the hook member 18 is also pulled in the direction of the directional arrow 54. As a result, the gap shunt portion 38 pushes against the bias of the bias spring 44 causing the bias spring 44 to compress and causes the gap shunt portion 38 to contact the two gap ends 32 of the first and second electrical conductors 30. As a result, the gap shunt portion 38 causes the circuit to be complete between the battery power source 16 and the hook member 18, thereby causing the fish 11 to feel an electric shock from the battery power source 16.

If while hooked, the fish 11 moves toward the housing lure assembly 12, the bias spring 44 extends and pushes the gap shunt portion 38 away from the gap ends 32, thereby causing the electric shock to cease. The electric shock can alternatively be applied to the fish 11 and not applied to the fish 11 depending upon the pull or the push of the fish 11 with respect to the bias spring 44 and the housing lure assembly 12. Such treatment of the fish 11 causes the fish 11 to quickly exhaust its energy, further reducing the chance for escape.

In general, when a pulling tension on the bias spring 44 is removed, the bias spring 44 pushes the gap shunt portion 38 away from the gap ends 32 causing the shock circuit to be opened so that no shocking occurs.

To replace the hook member 18, the hook fastener 46 is operated to allow the hook connection ring 52 to be removed from the hook fastener 46. A new hook member 18 can be attached to the hook fastener 46. To change the battery power source 16 or to change the illumination source 20, the housing cap portion 24 is unscrewed from the main housing body portion 14. Then the battery power source 16 or the illumination source 20 is replaced, and the housing cap portion 24 is screwed back onto the main housing body portion 14.

The components of the electric shock fishing lure apparatus of the invention can be made from inexpensive and durable metal and plastic materials and electrical components.

It is understood that while certain forms of this invention have been illustrated and described, it is not limited thereto except insofar as such limitations are included in the following claims and allowable functional equivalents thereof.

1. An electric shock fishing lure apparatus, comprising:
a main housing body portion defining an interior area;
a battery positioned in said interior area;
an electrically conductive switch shaft that is electrically connected to said battery and is movably situated in a distal end of said main body portion and movable between an extended configuration in which said switch shaft is energized by electrical current from said battery and a retracted configuration in which said switch shaft is not energized by current from said battery;
a bias spring coupled to said switch shaft and to said distal end of said housing for biasing said switch shaft toward said retracted configuration; and
an electrically conductive hook member situated outside said interior area of said main housing body portion and operatively coupled to an outside end of said switch shaft, said electrically conductive hook member being energized when said switch shaft is at said extended configuration.

2. The electric shock fishing lure apparatus of claim 1, further comprising:
first and second electrical conductors electrically connected to said battery and positioned to define an electrical shunt gap therebetween;
a gap shunt portion connected to an inside end of said switch shaft, said gap shunt portion configured to selectively close said electrical shunt gap when said switch shaft is at said extended configuration; and
wherein electricity is communicated between said first and second conductors to said switch shaft when said shunt gap is closed.

3. The electric shock fishing lure apparatus of claim 1, further comprising an illumination member positioned in said interior area of said main housing body portion that is electrically connected to said battery, said battery energizing said illumination member.

4. The electric shock fishing lure apparatus of claim 3 wherein said main housing body portion is constructed of a translucent material.

5. The electric shock fishing lure apparatus of claim 4, further comprising a switch fastener intermediate said electrically conductive hook member and an outside end of said switch shaft, said hook member being removably coupled to said switch fastener.

6. The electric shock fishing lure apparatus of claim 1, wherein said distal end of said main body portion includes a watertight seal, said switch shaft being received in said watertight seal.

7. The electric shock fishing lure apparatus of claim 1, further comprising a housing cap portion removably coupled to said main body portion, said interior area being accessible when said housing cap portion is removed.

8. The electric shock fishing lure apparatus of claim 7, wherein said housing cap portion includes threads that are complementary to threads on said main body portion for releasable engagement therewith.
